(19) United States
(12) Patent Application Publication
(10) Pub. No.: US 2007/0085336 A1
(43) Pub. Date: Apr. 19, 2007

(54) Security label

(76) Inventor: Frank Konrad Doermer, Reutlingen (DE)

Correspondence Address: MICHAEL J. STRIKER, 103 EAST NECK ROAD, HUNTINGTON, NY, 11743, US

(21) Appl. No.: 10/580,745

(22) PCT Filed: Nov. 26, 2004
(86) PCT No.: PCT/EP04/13488

§ 371 Date: Dec. 14, 2006

(30) Foreign Application Priority Data
Nov. 26, 2003 (DE) 203 18 483.1
Nov. 26, 2003 (DE) 20 2004 003 313.5
Nov. 26, 2003 (DE) 20 2004 004 040.9

(51) Int. Cl. B42D 15/00

(52) U.S. Cl. 283/81

(57) ABSTRACT

The invention relates to security labels for concealing information that is applied to different types of media, such as plastic cards, paper or similar and that is designed only for the attention of an authorised user. The application of an interference layer (23) to said security labels prevents the information from being discovered. A printed image (4), which is applied using a reactive dye to the rear face of the backing (1) or to the front face or to the covering label (32), prevents untraceable dissolution by a solvent Thermal welding (60) or embossing (70) also excludes transillumination from the label side. The action of security elements such as void effects are safeguarded by appropriate geometric ratios of the individual layers and in addition, the thermal joining process is improved or made possible by the application of appropriate media (61).

The present invention relates to a security label, which serves to conceal information in the form of character strings that are intended to be made known solely to an authorized user; the information is applied between two labels, and in the lower label has a transparent film layer, an adhesive layer on the underside, an upper layer applied as an interference field, and a layer applied over that for applying the information, and the covering from above is assured by known security rubble labels.

Various security labels of this type and for the aforementioned purpose are known from German Patents DE 197 05 380 C1 and DE 198 40 733 C2. In the known covering labels, the security features are either embodied over the full surface in the film layer or are embodied in framelike fashion by a so-called void film. The already known void film is intended to make any authorized lifting off of the film apparent by making any lifting off of the film permanently visually obvious. It is intrinsic to the known security labels that they are each applied to a relatively thick and nontransparent substrate medium. These are typically debit cards, such as cell phone cards and the like.

Safety labels that cover the information from above by means of a film layer, among other means, are already known. It is known that the information continues to adhere to this film layer when the upper film layer is detached. The attempt has been made to prevent legibility of the information by providing that the information is applied to a black ink layer, which is also peeled off as the upper film layer is detached and which thus hides the information.

However, the problem arises as a result that because of the layer thickness of the information applied, despite the black ink layer, the information remains visible by reflection. Moreover, it has been possible to demonstrate that one can begin to detach the adhesive used and thus to detach the entire security label in a way that cannot be made tamper-evident and to make the information readable through the missing interference layer. A further problem has been recognized, which is that the information or the label could not be applied to simple paper, since then the information could be detected by shining light through it, without the tampering being evident. Because of the previous use of such substrate media as plastic cards and the like, the problem of recycling these media is always present. Moreover, until now it way too complicated and expensive to have the information applied individually by the end user.

For the present invention, it is therefore the object to create a security label which avoids the disadvantages described and in which it is assured that any tampering or attempted or successful learning of the information is unambiguously apparent at a glance even to a layperson, and that the security label can be used independently of the substrate media, and emphasis is also placed, while maintaining security, on the possibility of easy, versatile, and inexpensive use. Moreover, despite detachment of the upper film layer, it must be assured that the information carried with it does not become legible, or that unauthorized reading becomes and remains immediately apparent.

This object is attained by a security label of the type defined at the outset, which is characterized in that

the information to be concealed is applied between two labels that each on their own and in cooperation have different security features;

in the region of lower label, the lower film layer has at least the size of the character string and is provided, at least in the region of the information to be concealed, with an interference field;

the interference field has at least the layer thickness of the information to be applied;

above the interference field, an upper layer is applied, on which the information can be applied, and the upper layer has at least the size of the character string.

With the invention, it is attained that the imprinted information cannot be detected by shining light through it from either the top or the bottom of the label. This is accomplished by providing that the information is printed on an interference field, which comprises an arbitrary order of numbers printed inside one another. Because of the at least equal layer thickness of the imprint and the interference field, it is attained that after the information is printed, mirror effects on the underside of the interference layer, which lead to legibility of the information, are avoided.

As a result, the user receives a security label which can be favorably manufactured in great numbers. Because the end user of the finished security labels, which can be peeled off a substrate film and then used for many different kinds of uses, a considerable simplification of applying security features to different media is assured. The protective information, such as PIN numbers, can easily be kept on hand and not applied to the appropriate medium until needed.

It is also possible, using commercially available printers, to imprint the lower part of the security label, previously applied to a substrate media, with the information at the specifically required instant and then, by the simple operation of joining it to the upper part of the security label to close it and thus securely protect the information.

An advantageous embodiment of the invention is defined by claim 2. Here, the problem has occurred until now that a perfect connection between the two parts of the security label must be assured in order to make impermissible separation of them at least extremely difficult. The problem arises that the upper layer and the interference field disadvantageously affect the connection of the upper and lower labels.

Solving this problem is attained by a security label of the type defined above which is characterized in that

around the field for the information, an uncoated frame out of the substrate film remains free.

The refinement defined by claim 2 makes a better connection with the covering rubble label possible in the region of the free frame. In particular, this assures increased security against chemical attacks by solvents.

A further advantageous feature is recited in claim 3. It has been found that under some circumstances, the two security labels can be separated from one another by means of solvents. This can initially be made quite difficult by means of the embodiment of claim 2. However, if such separation is successfully accomplished, then the embodiment of claim 1 can initially prevent the information from becoming legible. However, after that, the attempt may be made to detach the ink and information layers, which are carried along with the upper label, in dry fashion in order to arrive at the information. Then the already known void effect is tripped over the entire surface of the dry-detached ink and information layer.

However, the problem arises that the already known void effect, reliably tripped then by the detachment, on the upper film may under some circumstances not become visible, since it is concealed from above by the rubble layer and from below by the re-applied ink and information layer.

The solution to this problem is attained by a security label of the type defined above, which is characterized in that

the upper layer on which the information is applied is designed to be so large that an uninscribed edge without information is created, which is covered over its entire surface by the upper label such that the rubble layer conceals only the information, and at least the unwritten edge is covered by a so-called void film.

The refinement in accordance with claim 3 makes it possible, upon separation of the ink and information layer adhering to the upper label, for the void effect to be tripped at a point of the upper label that is not covered by the rubble field and thus remains permanently visible. It is therefore appropriate for the entire upper label to be designed as a so-called void film.

By means of an imprint described in claims 4 through 6, a further enhancement to security can be achieved. This is characterized in that

a printed image in the form of graphic patterns and/or characters is applied to the rubble paint layer and at least in the region of this layer by means of a reagent ink which is indirectly or directly visible;

a printed image is applied to the front side in the form of graphic patterns and/or characters on the background (substrate medium) on which the lower label is applied, by means of reagent ink which is indirectly or directly visible;

the printed image is applied to the back side of the background (substrate medium).

Because of the graphic imprint of reagent ink, it is attained that the label cannot be treated with an adhesive-dissolving fluid without causing a washed-out effect in the printed image. This assures that any influence on the security label becomes immediately apparent. Simple copying or counterfeiting is prevented by the technically high-quality printed image. The imprint can be made selectively on the upper label, on the front side of the substrate media directly, or on the back side of the substrate media. In the latter two variants, it is advantageous that imprinting the substrate media with the reagent ink can be done independently of the gluing on of the security label, and thus paper, for instance, can be imprinted in great numbers, leading to a cost reduction. The substrate media can furthermore be used or kept on hand independently of the security label.

A further advantageous feature of the security label is described in claim 7. It has been found that the interference field already mentioned above and as described above requires a minimum layer thickness so that the imprinted information, despite the interference field, remains undetectable. A problematic aspect here is how this layer thickness can be achieved.

Attaining this object is achieved by a security label of the type defined above which is characterized in that

the interference field is produced by means of screenprinting.

As a result, an adequate layer thickness is achieved, since the ink application is substantially greater than with other printing techniques.

The present invention relates to a security label which serves to conceal information in the form of character strings that are intended to be made known solely to an authorized user. The security label can be used primarily to conceal security-related information such as PIN numbers on different media, such as plastic cards or even simple paper. In this case the security label comprises at least one substrate layer, which in turn comprises an upper layer and below it an adhesive layer. An absorption layer of at least the same area as the information to be covered is applied under the adhesive layer.

Various security labels of this type and for the aforementioned purpose are known from German Patents DE 197 05 380 C1 and DE 198 40 733 C2. In the known covering labels, the security features are either embodied over the full surface in the film layer or are embodied in framelike fashion by a so-called void film. The already known void film is intended to make any authorized lifting off of the film apparent by making any lifting off of the film permanently visually obvious. It is intrinsic to the known security labels that they each have a an adhesive layer, and the adhesive comes to rest on the information.

It has been found that by means of various technical devices, it is possible for the already known security labels to be tampered with, without tripping the security devices, such as the so-called void film. In this respect, it is a disadvantage of the known security labels that in their layer structure they have one continuous adhesive layer, which serves to join the label permanently to the background. The adhesive layer comes into direct contact with the information layer in that case and surrounds the individual parts of the information. This represents a major security gap.

By means of suitable aids, it is possible, by way of the continuous adhesive layer and using the optical fiber effect, to make the information concealed under the middle of the label visible, without damaging the label itself or exerting any mechanical or chemical influence. For the present invention, the object is therefore to create a security covering which overcomes the disadvantages described and in which it is assured that tampering or unauthorized procurement of information through the security devices of the label is not only made visible but also actively prevented. The security label should be usable independently of the substrate media, and while maintaining security, emphasis is placed on the possibility of easy, versatile, and inexpensive use.

This object is attained by a security covering according to the invention of the type defined at the outset, which is characterized in that

an absorption layer is applied on the underside of the adhesive layer in such a way that

the absorption layer has a greater extent than the information field to be concealed and at least completely covers it and is smaller than the substrate layer; and

this absorption layer is a parting layer between the covering adhesive layer and the information layer.

With the invention, it is attained that the imprinted information cannot be detected from the top and from the underside of the label by shining light through it. In the invention, this is attained by providing that the information can be reached directly from outside by means of radiation. Since the adhesive layer can problematically be used as an optical waveguide, it is thus attained that the light waves do not reach the information layer but instead are either absorbed by the absorption layer and thus rendered harmless or are deflected past the information layer, without it being possible for the information to be made visible. Because of the presence of the separation and absorption layer, the effect of the different energy absorptions of the adhesive and the information is reduced to a minimum. Obtaining readable information is thus prevented. By means of the intermediate layer, a reliable decoupling of information and all the layers extending to the edge of the label is attained. The decoupling layer here has at least the extent of the information, in order to assure a secure function.

An advantageous feature of the invention is defined by claim 9. This describes an embodiment which comprises a known security label and is designed according to the invention, characterized in that

the upper layer is designed as a transparent film;

that on the substrate layer there is a so-called rubble field, which covers the information from above; and

that the absorption layer comprises a transparent film.

The refinement according to claim 9 makes it possible utilize the advantages of the known security labels yet to protect the information reliably against lateral attacks. Here, the known rubble label can be used, which is provided with a so-called void film. To enable detection of the information after authorized removal of the rubble layer, the absorption layer is embodied by means of a transparent film.

A further advantageous feature is recited in claim 10. It has been found that upon decoupling of information and the cover layer by means of suitable options, a void can be created between the information and the covering.

This can promote unauthorized reading out of the information. The solution to this problem is attained by a security label of the type defined above which is characterized in that

an adhesive layer, which represents a firm connection between the absorption layer and the information field, is located under the absorption layer.

The refinement in accordance with claim 10 makes it possible for the absorption layer to adhere firmly to the information so that it cannot be separated in such a way that a void is created. Expediently, the adhesive layer is the same size as the absorption layer.

When the rubble field is used as a cover layer, it has been found that the rubble field can be removed and after unauthorized reading of the information, the rubble layer can be simulated. Thus the intactness of the information can be simulated. This is a known way, already described in German Patent DE 198 40 733 C2, of circumventing the security devices of the label. Until now, the attempt has been made to prevent this by means of an imprint on the rubble layer. The problem always arises, however, that this security device is applied to the label at the ton and is therefore always exposed to direct influences. These problems are solved according to the invention such that

the absorption layer is an opaque layer, and the upper layer may comprise a film or so-called void film or a simple paper.

By means of the embodiment according to claim 11, it is possible in making the security label to dispense with the rubble field entirely. On the one hand, this makes rational, simple and hence economical production of the security label possible, since the operation of applying a rubble field can be dispensed with; on the other, the security device is concealed in the interior of the label and can be tampered with only by opening the entire label. Doing so, however, makes the known so-called void film reliably visible.

In accordance with the statements made in claim 10, the security can also be enhanced according to the invention, in conjunction with the opaque separation layer, by means of an additional adhesive layer in that

an adhesive layer is located under the absorption layer and involves an adhesive of the kind which when the label is peeled off does not destroy the information layer.

The adhesive layer described here is adjusted such that the information is not destroyed upon opening and peeling off of the entire security label and expediently is the size of the absorption layer.

A further improvement in security is attained by providing that below the absorption and separation layer, a so-called interference layer is located, and accordingly the invention is accordance with claim 13 is designed such that

the absorption layer is provided with a further layer located under it that is embodied as a so-called interference field, which comprises statistically randomly distributed fragments of characters and!or serpentine lines and/or similar patterns.

It is attained here that the unauthorized readout of the label by means of the optical waveguide effect or by targeted heating of the label is made more difficult. By means of a random character string in the interference layer, it is not possible to distinguish this character string upon unauthorized reading out of the information. Obtaining usable information can thus be prevented. The interference field is expediently also the same size as the absorption layer.

In accordance with the statements made in claim 12, the security can be improved in accordance with claim 14 in that

a further adhesive layer is located under the interference field and involves an adhesive of the kind that when the label is peeled off does not destroy the information layer.

Once again, the described advantages are utilized in the expedient embodiment.

Supplementing the label with many security devices makes it difficult to manufacture the label simply and hence economically. It is therefore the object to obtain the achieved security of the label and to design the structure simply. This problem is solved according to the invention as defined in claim 15 in that

the absorption layer itself is embodied as a so-called interference field.

The advantage of this embodiment is that the absorption layer need not comprise opaque material; instead, the nontransparency is assured by the interference field. Furthermore, the advantages listed of the absorption and separation layer and of the interference field are united in one layer. This too makes more-economical production of the label possible.

According to claim 16, the advantages of claim 10 and 15 are advantageously combined. By the embodiments according to the invention, on the one hand the unauthorized readout of the information is reliably prevented, and on the other, if unauthorized reading has actually occurred, it is immediately made evident. This is embodied such that

the absorption layer is an opaque layer, and the upper layer may comprise a film or so-called void film or a simple paper.

As described above, an attack can be made in particular through the adhesive layer, which necessarily joins the label to the underlayer. This problem is prevented according to the invention by including an absorption and separation layer. According to claim 17, the safety devices described are improved in that

the adhesive layer is interrupted in a region that in framelike fashion surrounds the absorption layer.

Once again, if the attack on the information from outside is made by means of the described optical waveguide effect, then the light waves are already interfered with early inside the adhesive layer, so that a readout is no longer possible.

Safety labels that cover the information from above by means of a film layer, among other means, are already known. It is known that the information continues to adhere to this film layer when the upper film layer is detached. The attempt has been made to prevent legibility of the information by providing that the information is applied to a black ink layer, which is also peeled off as the upper film layer is detached and which thus hides the information on the underside.

However, the problem arises as a result that because of the layer thickness of the information applied, despite the black ink layer, the information remains visible by reflection. Moreover, it has been possible to demonstrate that one can begin to detach the adhesive used and thus to detach the entire security label in a way that cannot be made tamper-evident and to make the information readable through the a missing so-called interference layer. A further problem has been recognized, which is that the information or the label could not be applied to simple paper, since then the information could be detected by shining light through it, without the tampering being evident. Because of the previous use of such substrate media as plastic cards and the like, the problem of recycling these media is always present. Moreover, until now it way too complicated and expensive to have the information applied individually by the end user.

For the present invention, it is therefore the object to create a security label which avoids the disadvantages described and in which it is assured that any tampering or attempted or successful learning of the information is unambiguously apparent at a glance even to a layperson, and that the security label can be used independently of the substrate media, and emphasis is also placed, while maintaining security, on the possibility of easy, versatile, and inexpensive use. Moreover, despite detachment of the upper film layer, it must be assured that the information carried with it does not become legible, or that unauthorized reading becomes and remains immediately apparent.

This object is attained by a security label of the type defined at the outset, which is characterized in that

the information to be concealed is applied between two labels that each on their own and in cooperation have different security features;

in the region of lower label, the lower film layer has at least the size of the character string and is provided, at least in the region of the information to be concealed, with an interference field;

the interference field has at least the layer thickness of the information to be applied;

above the interference field, an upper layer is applied, on which the information can be applied, and the upper layer has at least the size of the character string.

With the invention, it is attained that the imprinted information cannot be detected by shining light through it from either the top or the bottom of the label. This is accomplished by providing that the information is printed on a so-called interference field, which comprises an arbitrary order of numbers printed inside one another. Because of the at least equal layer thickness of the imprint and the interference field, it is attained that after the information is printed, mirror effects on the underside of the interference layer, which lead to legibility of the information, are avoided.

As a result, the user receives a security label which can be favorably manufactured in great numbers. Because the user can use the finished security label, which can be peeled off a substrate film and then be used for many different kinds of uses, a considerable simplification of applying security features to different media is assured. The protective information, such as PIN numbers and secret numbers, can easily be kept on hand and not applied to the appropriate medium until needed.

It is also possible, using commercially available printers, to imprint the lower part of the security label, previously applied to a substrate media, with the information at the specifically required instant and then, by the simple operation of joining it to the upper part of the security label to close it and thus securely protect the information.

It is considered especially advantageous to use the known security label (PDMA serial number 20 2004 003 313.5) as an upper label, since in that case its positive, known properties can advantageously be integrated into the present invention. A further increase in protection is thus attained.

An advantageous embodiment of the invention is defined by claim 19. Here, the problem has occurred until now that a perfect connection between the two parts of the security label must be assured in order to make impermissible separation of them at least extremely difficult. The problem therefore arises that the upper layer and the interference field disadvantageously affect the connection of the upper and lower labels.

Solving this problem is attained by a security label of the type defined above which is characterized in that

around the field for the information, an uncoated frame out of the substrate film remains free.

The refinement defined by claim 19 makes a better connection with the covering rubble label possible in the region of the free frame. In particular, this assures increased security against chemical attacks by solvents.

A further feature of the invention is defined by claim 20. Basically, the target of the attempt to procure the protected information without authorization is always the information field in the middle between the two labels. It is therefore the object of the invention not only to make the unauthorized penetration into the security label, or the separation of the two labels, reliably obvious but also largely to prevent this.

This is attained according to the invention by a security label which is characterized in that

the two labels in the region of the unwritten frame (22b) out of the substrate film (22) are joined together all the way around the field for the information (50) by means of a laser weld (60); and that in the region of the weld, a suitable medium (61) is applied to the frame (22b) of the substrate film (22), which medium favorably affects the weld (60).

The embodiment according to the invention is defined by claim 20 makes it possible actively to prevent the penetration into the security label from outside using suitable media or even the separation of the label by beginning to dissolve the adhesive layers. The weld makes a simple and secure connection possible between the two labels that can be separated only by strong mechanical action. It thus always remains assured that the information is completely isolated from the outer edge.

As further protection, it is appropriate that the weld seam is not a simple straight line extending in framelike fashion around the information but instead is a more-complicated pattern. As a consequence, producing this weld seam is technologically more demanding, and unauthorized simulation is thus made considerably more difficult.

It has been found that the welding can be more successful if a black ink is applied to the freely remaining frame of the substrate film and thus in the region of the weld. Dependent claim 21 therefore protects a security label as defined by claim 20, characterized in that

in the region of the weld, a suitable medium is applied to the frame of the substrate film, which medium favorably affects the weld.

Because the designated part of the lower substrate film is coated with a medium in the region of the weld seam, it is attained that the joining of the two films can be reliably produced by means of laser welding. As one option for the medium, black ink can be used.

A suitable embodiment for the problem recited in connection with the statements on claim 20 is obtained from claim 22, which is directed to a security label which is characterized in that

the two labels are joined together in the region of the frame by means of an encompassing embossing on the covering upper label.

By means of the embossing technique, a secure and at the same time simple connection between the two labels is attained. The advantages of this embodiment correspond to those of claim 20.

A further advantageous feature is recited in claim 23. It has been found that under some circumstances, the two security labels can be separated from one another by means of solvents. This can initially be made quite difficult by means of the embodiment of claim 19 and prevented entirely by means of claims 20 through 22. However, if such separation is successfully accomplished, then the embodiment of claim 18 can initially prevent the information from becoming legible. However, after that, the attempt may be made to detach the ink and information layers, which are carried along with the upper label, in dry fashion in order to arrive at the information. Then the already known void effect is tripped over the entire surface of the dry-detached ink and information layer.

However, the problem arises that the already known void effect, reliably tripped then by the detachment, on the upper film may under some circumstances not become visible, since it is concealed from above by the rubble layer and from below by the re-applied ink and information layer.

The solution to this problem is attained by a security label of the type defined above, which is characterized in that

the upper layer on which the information is applied is designed to be so large that an uninscribed edge without information is created, which is covered over its entire surface by the upper label such that the rubble layer conceals only the information, and at least the unwritten edge is covered by a so-called void film.

The refinement in accordance with claim 20 (23) makes it possible, upon separation of the ink and information layer adhering to the upper label, for the void effect to be tripped at a point of the upper label that is not covered by the rubble field and thus remains permanently visible. It is therefore appropriate for the entire upper label to be designed as a so-called void film.

By means of an imprint described in claims 21 (24) through 23 (26), a further enhancement to security can be achieved. This is characterized in that

a printed image in the form of graphic patterns and/or characters is applied to the rubble paint layer and at least in the region of this layer by means of a reagent ink which is indirectly or directly visible;

a printed image is applied to the front side in the form of graphic patterns and/or characters on the background (substrate medium) on which the lower label is applied, by means of reagent ink which is indirectly or directly visible;

the printed image is applied to the back side of the background (substrate medium).

Because of the graphic imprint of reagent ink, it is attained that the label cannot be treated with an adhesive-dissolving fluid without causing a washed-out effect in the printed image. This assures that any influence on the security label becomes immediately apparent. Simple copying or counterfeiting is prevented by the technically high-quality printed image. The imprint can be made selectively on the upper label, on the front side of the substrate media directly, or on the back side of the substrate media. In the latter two variants, it is advantageous that imprinting the substrate media with the reagent ink can be done independently of the gluing on of the security label, and thus paper, for instance, can be imprinted in great numbers, leading to a cost reduction. The substrate media can furthermore be used or kept on hand independently of the security label.

A further advantageous feature of the security label is described in claim 24 (27). It has been found that the interference field already mentioned above and as described above requires a minimum layer thickness so that the imprinted information, despite the interference field, remains undetectable. A problematic aspect here is how this layer thickness can be achieved.

Attaining this object is achieved by a security label of the type defined above which is characterized in that

the interference field is produced by means of screenprinting.

As a result, an adequate layer thickness is achieved, since the ink application is substantially greater than with other printing techniques.

Various exemplary embodiments of the invention will be described below in conjunction with a drawing. It should be noted that the drawings are not to scale, and the layer thicknesses are shown greatly exaggerated for the sake of clarity. The drawings are limited to the essential information and therefore do not always show the layer construction in detail. Shown are:

FIG. 1, the lower part of a security label in plan view, applied to a substrate media;

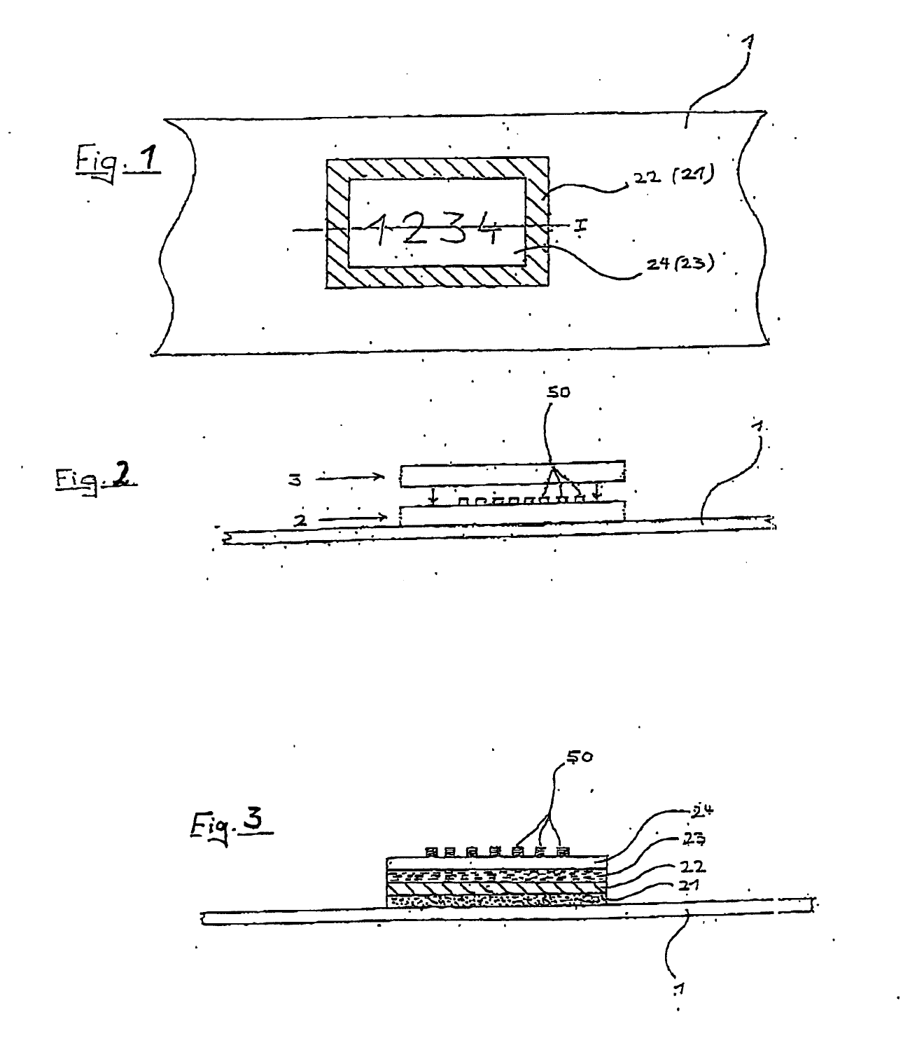

FIG. 2, a security label comprising one lower and one upper part, in cross section;

FIG. 3, the lower part of a security label, in cross section;

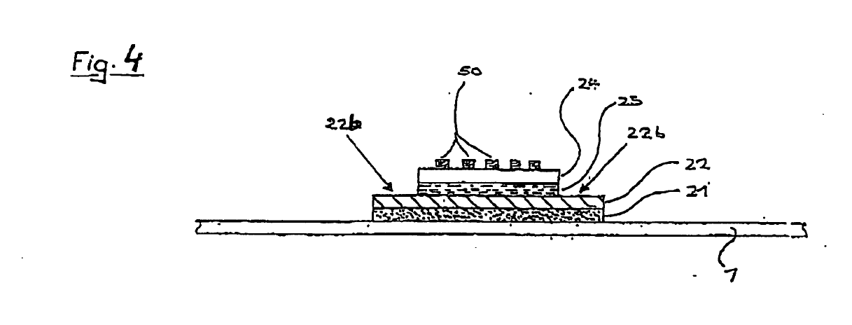

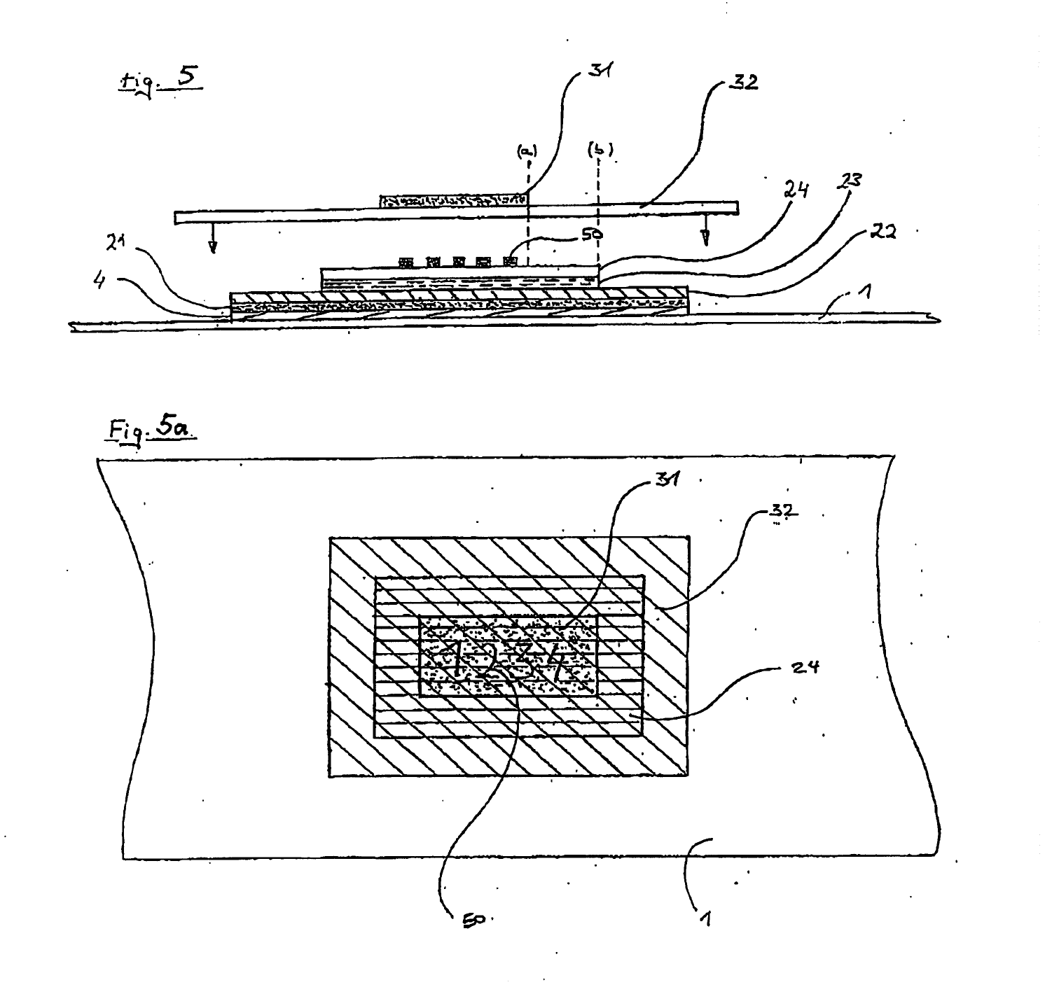

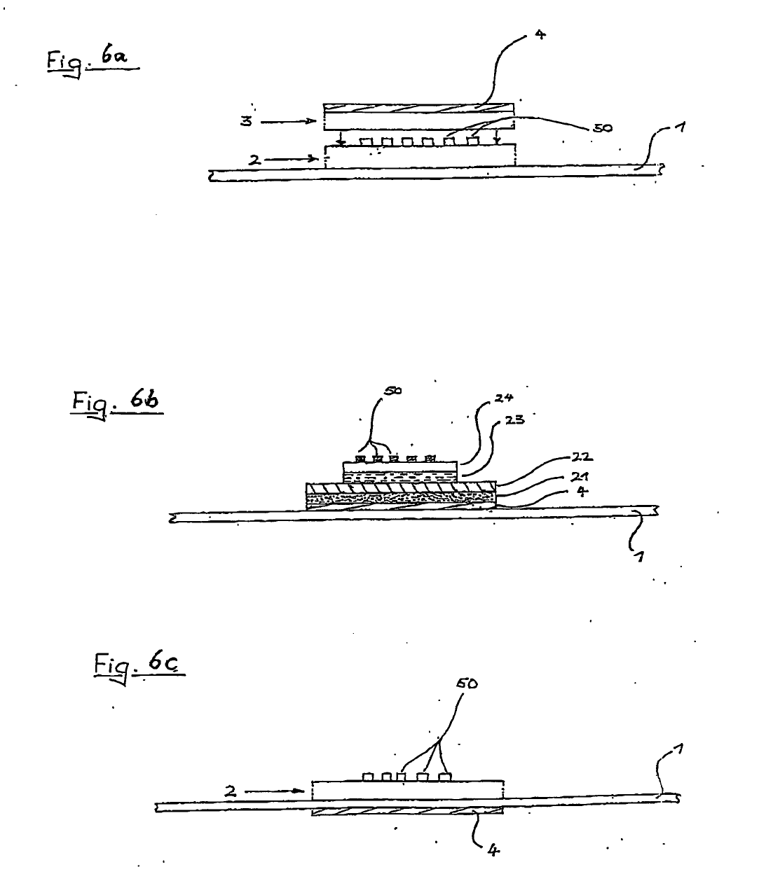

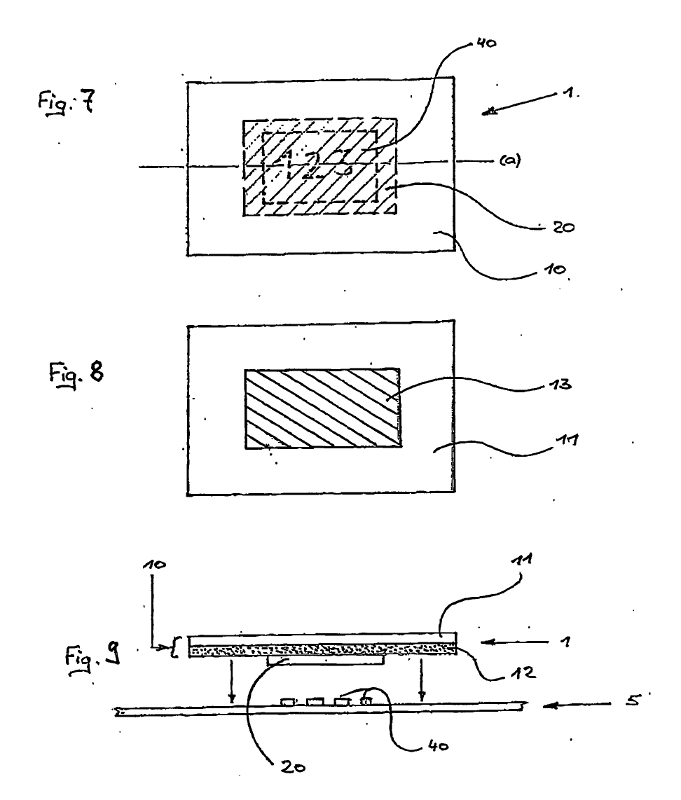

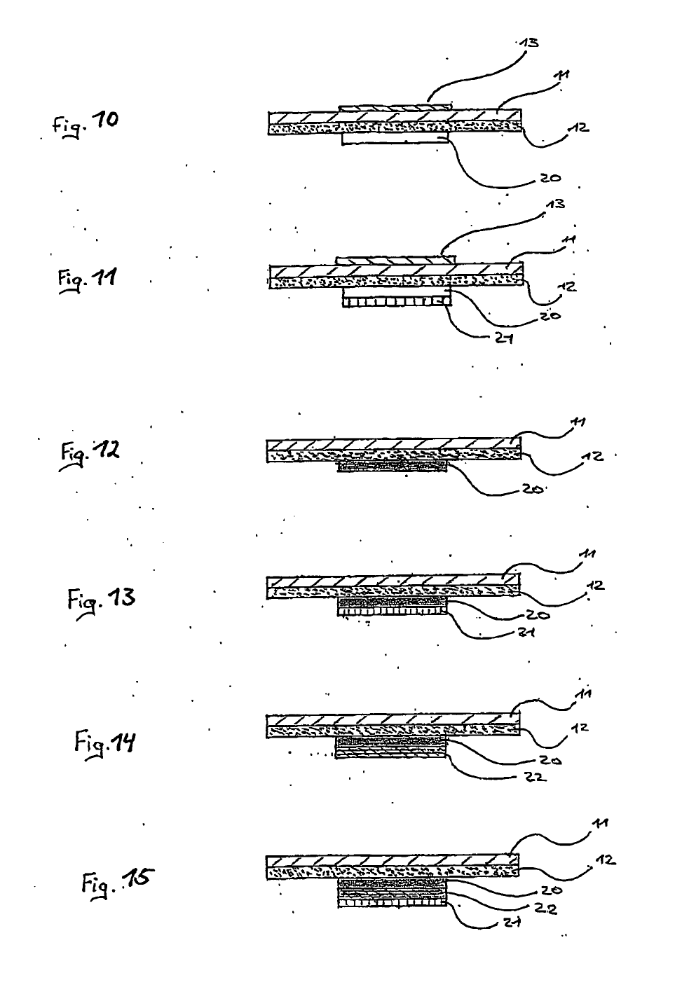

FIG. 4, a security label in cross section, showing an uncoated frame on the outside;

FIG. 5, a security label in cross section, with a smaller rubble field than the upper layer of the lower part of the label; and

FIGS. 6a through 6c, the security label with reagent ink imprint in the possible variants.

The exemplary embodiment shown in FIG. 1 of the lower part of a security label has a rectangular outline. The load-bearing part of the lower part (2) of the label is formed by a film layer (22) comprising a transparent plastic. This layer is applied to a substrate media (1) by means of an adhesive layer (21). Located in the middle of the film layer is the likewise rectangular interference field (23), covered with an upper layer (24), on which the information (the character string) (50) is located. The section line (I) to which the following drawings pertain is drawn in.

In FIG. 2, the layer construction of the security label is clearly shown, with the lower part (2) and the upper part (3). Located between them is the information (50). The arrows drawn between the layers illustrate the joining together of the two labels.

FIG. 3 shows the lower part of the security label in cross section; the layers are shown exaggeratedly large, for the sake of clarity. The security label is applied to an arbitrary substrate media (1), such as paper or the like. In the construction, the film layer (22) can first be seen, as a load-bearing part, which is applied by means of an adhesive layer (21) to the substrate media (1). The interference field (23) follows, and over it the upper layer (24), on which the information is imprinted. The information is covered from above by a known rubble label (3). This latter is not shown in this drawing.

In FIG. 4, it becomes clear from the cross section shown that the interference field (23) and the upper layer (24) here are smaller than the film (22) located below them. The optimal connection to the rubble label (3) is thus attained, since direct adhesive faces (22a) and (22b) are thus present between the substrate films.

FIG. 5 shows a possible embodiment of the security label, taking claim 5 into account. Once again, the lower part of the label is joined to an arbitrary substrate media. The layer construction is equivalent to that of FIG. 4. It becomes clear that the rubble layer (31) in terms of its extent is smaller than the upper layer (24), but it is large enough to cover the information (50). It also becomes apparent that a region of the covering void film (32) between the dashed lines (a) and (b) is filled by the upper layer (24), which the void effect in the void film can trip visibly from above.

FIG. 5a shows the possible embodiment, described in FIG. 5, from above in plan view. For the sake of greater clarity, the layers are sometimes shown transparent. The void film (32), shown with diagonal shading, completely covers the lower label. The area (24), shaded crosswise, represents the upper layer, which clearly has a greater extent than the rubble layer (31) below which the information (50) drawn in here is located.

FIG. 6a shows a view like FIG. 2, with the corresponding imprint of a reagent ink as layer (4).

In FIG. 6b, the reagent ink layer (4) is printed directly onto the paper between the adhesive layer (21) and the substrate media (1). Once again the advantageous construction of the lower part of the label corresponding to FIG. 4 is shown.

Correspondingly, the imprint (4) in FIG. 6c is located on the underside of the substrate media (1). Thus three different variants can be shown, which display an advantageous embodiment of the application of the reagent ink. In the variants of FIGS. 6b and 6c, the substrate media can thus already be prepared and can be applied at this point to the security label at an arbitrary time.

FIG. 7 shows the label in plan view and in a view through it a lesser extent than the absorption and separation layer (20) located above it. The field (10) shows the substrate layer in its extent. The line (a) represents the section line for the cross sections of the label between shown in the other drawings.

FIG. 8 shows the label in closed form, with the rubble field (13) that covers the information from above.

FIG. 9 shows the label in cross section along the line (a) of claim 8. The order of the layers is thus clear: upper layer (11), adhesive layer (12), and absorption layer (20). The arrows indicate the application of the label to the medium (5) and indicate the information (40) applied to it beforehand. Once again, it can be seen that the information (40) has a lesser extent than the absorption layer (20).

In FIGS. 10 and 11, we have shown the label (1) with the additional rubble layer (13), and FIG. 11 also shows the adhesive layer (21) described in claim 10.

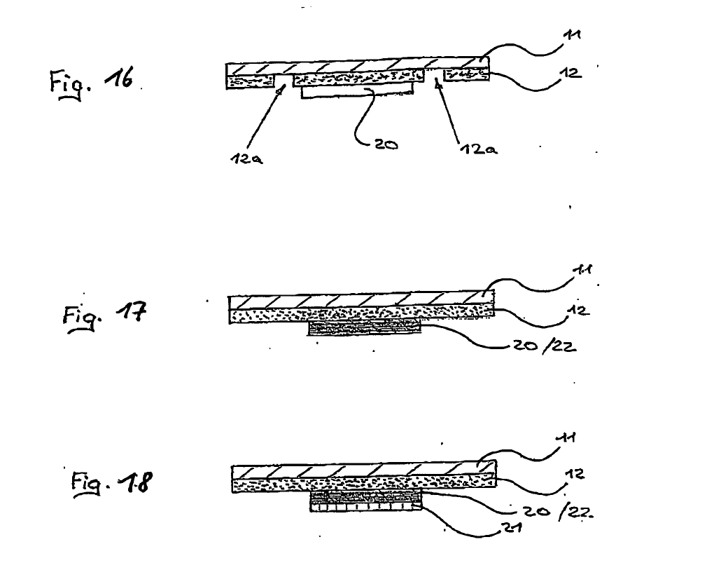

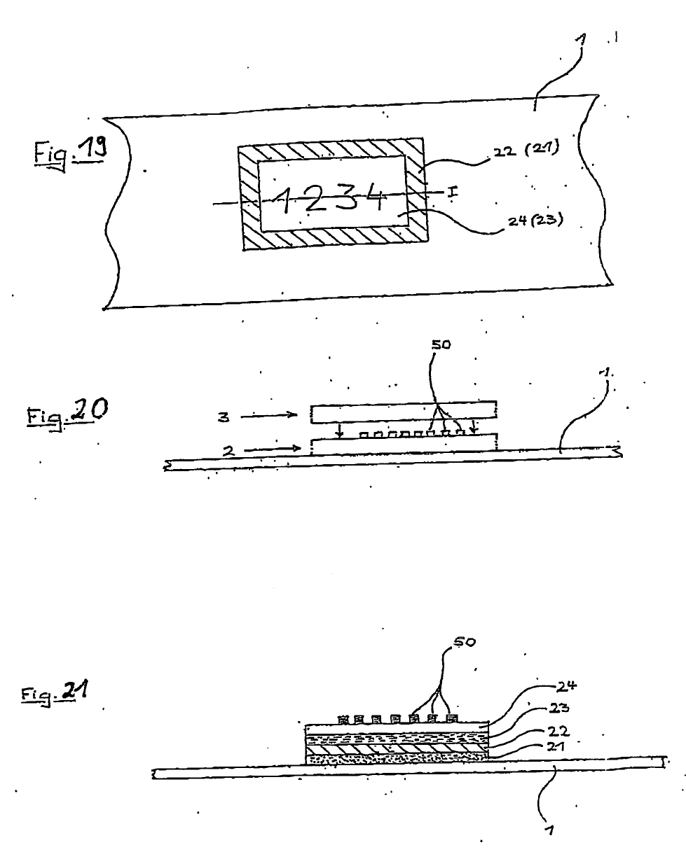

FIGS. 12 through 15 show possible embodiments of the label in accordance with claims 11 through 14. The layer construction is explained here. The absorption layer (20) as an opaque layer, the adhesive layer (21), and the interference field (28) are shown.

FIGS. 17 and 18 show an advantageous embodiment of the label in accordance with claims 15 and 16. Here, the absorption layer (20) designed as an interference field and the additional adhesive layer (21) are visible.

An embodiment of the claim in accordance with claim 17 is shown in FIG. 12. The upper layer (11), the adhesive layer (12), and the absorption layer (20) can be seen. The adhesive layer (12) is interrupted in framelike fashion in the region (12a). There is no adhesive there.

FIG. 19, the lower part of a security label in plan view, applied to a substrate media;

FIG. 20, a security label comprising one lower and one upper part, in cross section;

FIG. 21, the lower part of a security label, in cross section;

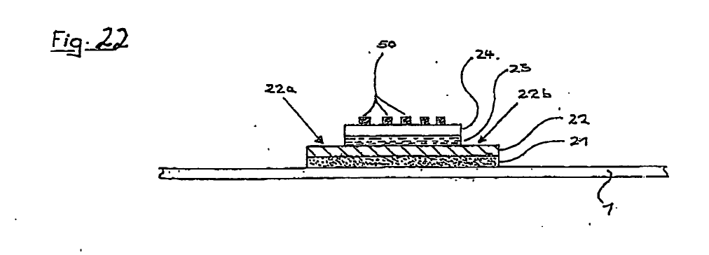

FIG. 22, a security label in cross section, showing an uncoated frame on the outside;

FIG. 23, a security label in plan view from above with the line for the welding/embossing drawn in;

FIG. 24, the two label parts, joined by embossing;

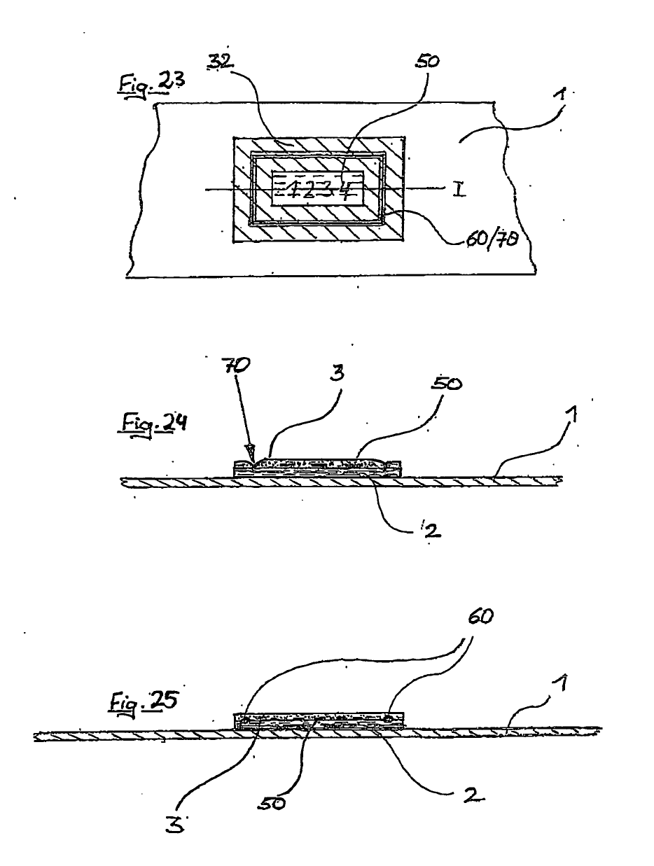

FIG. 25, the two label parts, joined by welding;

FIG. 26, the application of the medium for the weld connection;

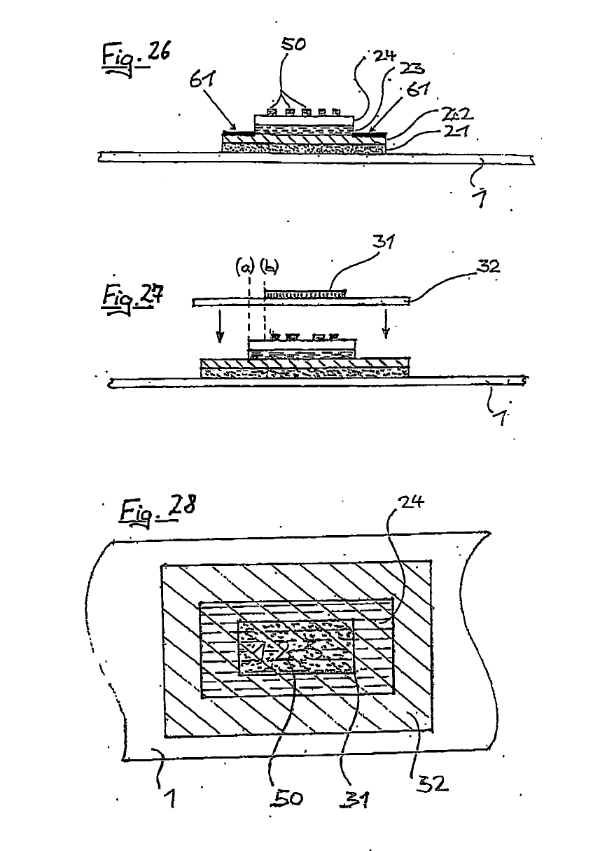

FIG. 27, a security label in cross section, showing a smaller rubble field than the upper layer of the lower part of the label; and FIG. 28, a plan view on the same label; and

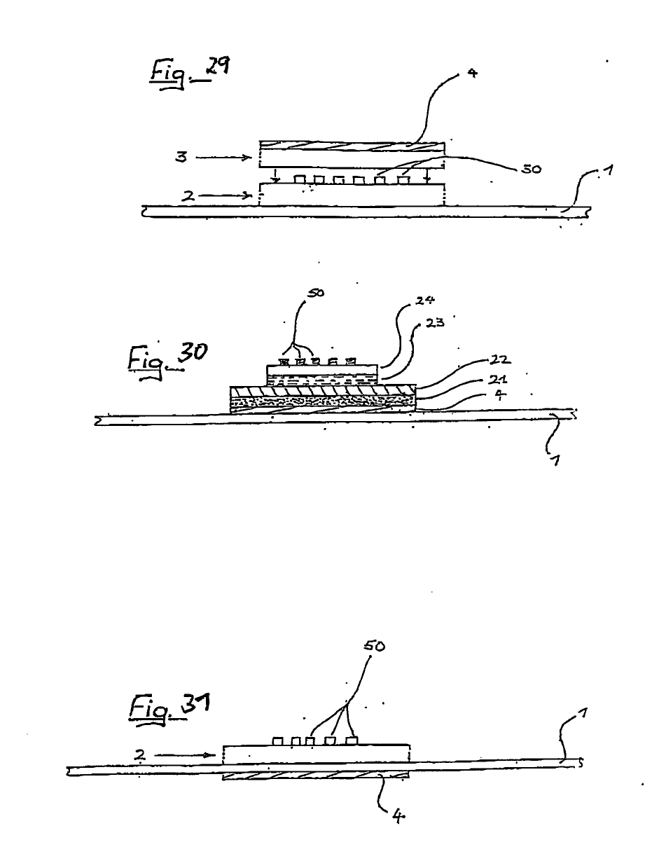

FIGS. 29 through 31, the security label with reagent ink imprint in the possible variants.

The exemplary embodiment shown in FIG. 19 of the lower part of a security label has a rectangular outline. The load-bearing part of the lower part (2) of the label is formed by a film layer (22) comprising a transparent plastic. This layer is applied to a substrate media (1) by means of an adhesive layer (21). Located in the middle of the film layer is the likewise rectangular interference field (23), covered with an upper layer (24), on which the information (the character string) (50) is located. The section line (I) to which the following drawings pertain is drawn in.

In FIG. 20, the layer construction of the security label is clearly shown, with the lower part (2) and the upper part (3). Located between them is the information (50). The arrows drawn between the layers illustrate the joining together of the two labels.

FIG. 21 shows the lower part of the security label in cross section; the layers are shown exaggeratedly large, for the sake of clarity. The security label is applied to an arbitrary substrate media (1), such as paper or the like. In the construction, the film layer (22) can first be seen, as a load-bearing part, which is applied by means of an adhesive layer (21) to the substrate media (1). The interference field (23) follows, and over it the upper layer (24), on which the information is imprinted. The information is covered from above by a known rubble label (3). This latter is not shown in this drawing.

In FIG. 22, it becomes clear from the cross section shown that the interference field (23) and the upper layer (24) here are smaller than the film (22) located below them. The optimal connection to the rubble label (3) is thus attained, since direct adhesive faces (22a) and (22b) are thus present between the substrate films.

FIG. 23 shows the embodiment of the label, applied to a substrate media (1) in accordance with claims 3 through 5, showing the covering rubble label (32) without the rubble layer (31). The framelike connection of the two labels by means of the weld or embossing seam (60/70) can be seen. The cross-section line (I) is also drawn in.

FIG. 24 shows the embodiment of claim 22, showing the two labels (3) and (2) as well as the embossing (70) and the information (50).

In FIG. 25, the two labels (3) and (2), the information (50), and here in particular the welded connections (60) are shown.

FIG. 26 shows the lower part of the security label with the known layer construction of the substrate media (1), adhesive layer (21), substrate layer (22), interference field (23), upper layer (24), information (50), and the suitable medium (61), present in accordance with claim 21, such as black ink, as a thick, black line.

FIG. 27 shows a further possible embodiment of the security label, taking claim 23 into account. Once again, the lower part of the label is joined to an arbitrary substrate media. The layer construction is equivalent to that of FIG. 22. It becomes clear that the rubble layer (31) in terms of its extent is smaller than the upper layer (24), but it is large enough to cover the information (50). It also becomes apparent that a region of the covering void film (32) between the dashed lines (a) and (b) is filled by the upper layer (24), which the void effect in the void film can trip visibly from above.

FIG. 28 shows the possible embodiment described in FIG. 27, from above in plan view. For the sake of greater clarity, the layers are sometimes shown transparent. The void film (32), shown with diagonal shading, completely covers the lower label. The area (24), shaded crosswise, represents the upper layer, which clearly has a greater extent than the rubble layer (31) below which the information (50) drawn in here is located.

FIG. 29 shows a view like FIG. 20, with the corresponding imprint of a reagent ink as layer (4).

In FIG. 30, the reagent ink layer (4) is printed directly onto the paper between the adhesive layer (21) and the substrate media (1). Once again the advantageous construction of the lower part of the label corresponding to FIG. 22 is shown.

Correspondingly, the imprint (4) in FIG. 31 is located on the underside of the substrate media (1). Thus three different variants can be shown, which display an advantageous embodiment of the application of the reagent ink. In the variants of FIGS. 30 and 31, the substrate media can thus already be prepared and can be applied at this point to the security label at an arbitrary time.

1. A security label for concealing information that is intended to be made known solely to an authorized user, characterized in that
the information to be concealed is applied between two labels that each on their own and in cooperation have different security features;
the lower film layer has at least the size of the character string and is provided, at least in the region of the information to be concealed, with an interference field;
the interference field has at least the layer thickness of the information to be applied;
above the interference field, an upper layer is applied, on which the information can be applied, and the upper layer has at least the size of the character string.

2. The security label as defined by claim 1, characterized in that around the field for the information, an uncoated frame out of the substrate film remains free.

3. The security label as defined by claim 1, characterized in that the upper layer on which the information is applied is designed to be so large that an uninscribed edge without information is created, which is covered over its entire surface by the upper label such that the rubble layer conceals only the information, and at least the unwritten edge is covered by a so-called void film.

4. The security label as defined by claim 1, characterized in that a printed image in the form of graphic patterns and/or characters is applied to the rubble paint layer and at least in the region of this layer by means of a reagent ink which is indirectly or directly visible.

5. The security label as defined by claim 1, characterized in that a printed image is applied to the front side in the form of graphic patterns and/or characters on the background (substrate medium) on which the lower label is applied, by means of reagent ink which is indirectly or directly visible.

6. The security label as defined by claim 5, characterized in that the printed image is applied to the back side of the background (substrate medium).

7. The security label as defined by claim 1, characterized in that the interference field is produced by means of screenprinting.

8. A security label for concealing information applied to a medium of a variable kind, such as plastic cards, paper and the like, which information is intended to be made known solely to an authorized user, in which the label (1) comprises at least one substrate layer (10) that comprises an upper layer (11) and an adhesive layer (12) located beneath the upper layer, characterized in that
an absorption layer (20) is applied on the underside of the adhesive layer (12) in such a way that
the absorption layer (20) has a greater extent than the information field (40) to be concealed and at least completely covers it and is smaller than the substrate layer (10), and
this absorption layer (20) is a parting layer between the covering adhesive layer (12) and the information layer (40).

9. The security label as defined by claim 8, characterized in that the upper layer (11 ) is designed as a transparent film; that on the substrate layer (10) there is a so-called rubble field (13), which covers the information (40) from above; and that the absorption layer (20) comprises a transparent film

10. The security label as defined by claim 9, characterized in that an adhesive layer (21), which represents a firm connection between the absorption layer (20) and the information field (40), is located under the absorption layer (20).

11. The security label as defined by claim 8, characterized in that the absorption layer (20) is an opaque layer, and the upper layer (11) may comprise a film or so-called void film or a simple paper.

12. The security label as defined by claim 11, characterized in that an adhesive layer (21) is located under the absorption layer (20) and involves an adhesive of the kind which when the label (1) is peeled off does not destroy the information layer (40).

13. The security label as defined by claim 11, characterized in that the absorption layer is provided with a further layer located under it that is embodied as a so-called interference field (28), which comprises statistically randomly distributed fragments of characters and/or serpentine lines and/or similar patterns.

14. The security label as defined by claim 13, characterized in that a further adhesive layer is located under the interference field and involves an adhesive of the kind that when the label (1) is peeled off does not destroy the information layer (40).

15. The security label as defined by claim 11, characterized in that the absorption layer (20) itself is embodied as a so-called interference field.

16. The security label as defined by claim 15, characterized in that the absorption layer (20) is an opaque layer, and the upper layer (11) may comprise a film or so-called void film or a simple paper.

17. The security label as defined by claim 1, characterized in that the adhesive layer (12) is interrupted in a region (12a) that in framelike fashion surrounds the absorption layer (20).

18. A security label for concealing information that is intended to be made known solely to an authorized user, characterized in that
the information (50) to be concealed is applied between two labels (3)1(2) that each on their own and in cooperation have different security features;
the lower film layer (22) has at least the size of the character string (50) and is provided, at least in the region of the information (50) to be concealed, with an interference field (23);
the interference field (23) has at least the layer thickness of the information (50) to be applied;
above the interference field (23), an upper layer (24) is applied, on which the information (50) can be applied, and the upper layer (24) has at least the size of the character string.

19. The security label as defined by claim 18, characterized in that around the field for the information (50), an uncoated frame (22b) out of the substrate film (22) remains free.

20. The security label as defined by claim 19, characterized in that the two labels (2)/(3) in the region of the unwritten frame (22b) out of the substrate film (22) are joined together all the way around the field for the information (50) by means of a laser weld (60):

21. The security label as defined by claim 20, characterized in that in the region of the weld, a suitable medium (61) is applied to the frame (22b) of the substrate film (22), which medium favorably affects the weld (60).

22. The security label as defined by claim 19, characterized in that the two labels (3)/(2) are joined together in the region of the frame (22b) by means of an encompassing embossing (70) on the covering upper label (3).

23. The security label as defined by claim 1, characterized in that the upper layer (24) on which the information (50) is applied is designed to be so large that an uninscribed edge ((a)-(b)) without information is created, which is covered over its entire surface by the upper label (3) such that the rubble layer (31) conceals only the information (50), and at least the unwritten edge ((a)-(b)) is covered by a so-called void film (32).

24. The security label as defined by claim 1, characterized in that a printed image (4) in the form of graphic patterns and/or characters is applied to the rubble paint layer (31) and at least in the region of this layer by means of a reagent ink which is indirectly or directly visible.

25. The security label as defined by claim 18, characterized in that a printed image (4) is applied to the front side in the form of graphic patterns and/or characters on the background (substrate medium) (1) on which the lower label (2) is applied, by means of reagent ink which is indirectly or directly visible.

26. The security label as defined by claim 25, characterized in that the printed image (4) is applied to the back side of the background (substrate medium) (1).

27. The security label as defined by claim 1, characterized in that the interference field (23) is produced by means of screenprinting.
